(19) United States
(12) Patent Application Publication
(10) Pub. No.: US 2014/0376909 A1
(43) Pub. Date: Dec. 25, 2014

(54) Optical Channel Monitor With High Resolution Capability

(71) Applicant: Finisar Corporation, Horsham, PA (US)

(72) Inventors: Steven James Frisken, Vaucluse (AU); Simon Poole, Waterloo (AU); Dmitri Abakoumov, Bondi (AU)

(73) Assignee: FINISAR CORPORATION, Horsham, PA (US)

(21) Appl. No.: 14/306,502

(22) Filed: Jun. 17, 2014

Related U.S. Application Data
(60) Provisional application No. 61/837,138, filed on Jun. 19, 2013.

(51) Int. Cl. H04J 14/02; H04B 10/079

(52) U.S. Cl. CPC H04J 14/0227; H04B 10/07955; H04B 10/07953; H04J 14/0223; H04Q 2011/0083
USPC 398/26; 398/38; 398/34

(57) ABSTRACT

Described herein is an optical channel monitor (1) including one or more input optical ports (3) for receiving an input optical signal (5) including a plurality of optical channels. A first monitoring module (7) is configured to selectively scan a predetermined spectral region of the optical signal including at least one optical channel for low resolution monitoring. A second monitoring module (11) is configured to simultaneously scan a subregion within the predetermined spectral region for high resolution monitoring.

### CROSS-REFERENCE TO RELATED APPLICATION

This application is a non-provisional application of U.S. Provisional Patent Application Ser. No. 61/837,138 filed Jun. 19, 2013, entitled “Optical Channel Monitor with High Resolution Capability.” The entire disclosure of U.S. Provisional Patent Application Ser. No. 61/837,138 is incorporated herein by reference.

### FIELD OF THE INVENTION

The present invention relates to monitoring optical signals in optical transmission systems, and in particular to an optical channel monitor for monitoring frequency modulated optical channels transmitted through a wavelength division multiplexed (WDM) optical system. While some embodiments will be described herein with particular reference to that application, it will be appreciated that the invention is not limited to such a field of use, and is applicable in other fields such as in wavelength selective switches and line cards.

### BACKGROUND

Any discussion of the background art throughout the specification should in no way be considered as an admission that such art is widely known or forms part of common general knowledge in the field.

Performance monitoring of optical channels is an important step in the assessment and management of a stable optical system. Performance monitoring is performed at various locations throughout an optical system using performance monitors such as optical channel monitors (OCMs). There exist a wide variety of OCMs, each with different functionality. Fast scanning OCMs generally provide only a low resolution sample of an optical channel, allowing identification of simple channel characteristics such as the channel peak wavelength and optical power. However, these fast scanning OCMs often allow monitoring of optical channels in real or near real-time. On the other hand, slow scanning OCMs provide higher resolution channel information, allowing the assessment of more advanced characteristics such as optical signal to noise ratio (OSNR), channel structure, dispersion and loss measurements. Some fast scanning OCMs are also capable of measuring the node origin or light path of the channel in the optical system.

One method of monitoring the OSNR and light path is to introduce a node-dependent, low frequency ‘pilot tone’ into each channel upon transmission and subsequently extract this pilot tone during the channel monitoring process. Extraction of the pilot tone frequency determines which node the channel originated from and the power level of the pilot tone can be used to discriminate signal power from noise power to determine the OSNR.

One example method for monitoring the light path and calculating the SNR in an optical system is described in U.S. Pat. No. 8,032,022 to Zhou and Feuer, entitled “Method for lightpath monitoring in an optical routing network”. Zhou and Feuer disclose overlaying a characteristic polarization pilot tone frequency on the optical channels and subsequently detecting the pilot tones in the electrical domain. Each node in the optical system applies a pilot tone having a specific frequency. Detection of the pilot tone frequency allows determination of the origin of the optical channel. Measuring the polarized pilot tone at specific polarization orientations allows determination of the unpolarized noise component and subsequent estimation of the OSNR. This technique requires a polarization modulator at each node to produce the required polarized pilot tones.

U.S. Pat. No. 7,054,556 to Wan et al. entitled “Channel identification in communications networks” relates to a technique for detecting light paths of optical channels in optical networks. Wan et al. modulates channels with two or more dither tones that are unique to a specific node or location within the network. The tones common to a channel are maintained with a known phase relationship and are decoded downstream to determine the channel origin. The decoding technique is performed in the electrical domain using averaging of fast Fourier transformed data. This process is relatively resource intensive and is difficult to perform in real-time monitoring.

Another method of detecting optical channel SNR is disclosed in US Patent Application Publication 2010/0129074 to Gariepy et al., entitled “In-band optical signal to noise ratio determination method and system”. Gariepy et al. measures the OSNR of optical channels by taking two separate measurements of each channel and comparing the two measurements. In a first technique, each channel is measured with two different polarization states. In a second technique, each channel is measured with two different filters having different spectral filter widths. In each technique, the noise is essentially constant and the difference in signal power can be used to distinguish the signal from noise, thereby allowing an estimate of the channel SNR to be produced. The techniques in Gariepy et al. do not allow the channel path to be determined.

In K. J. Park, C. J. Youn, J. H. Lee, and Y. C. Chung, “Optical path, wavelength, and power monitoring technique using frequency-modulated pilot tones,” in Optical Fiber Communication Conference, Technical Digest (CD), 2004, paper FF1. (Park et al 1.), a technique is disclosed for monitoring optical paths and channel wavelengths and powers using frequency modulated pilot tones. The optical frequency of each laser source is dithered with a small modulation frequency in the range 10 to 16 kHz with a separation of 1 kHz. The optical signal is passed through an arrayed-waveguide grating (AWG), which filters each channel. In transmission through the AWG, the power of the filtered channels is modulated according to the modulation frequency applied to the corresponding laser source. Monitoring of this amplitude modulation allows detection of the particular laser source or channel origin. A similar technique using phase modulated pilot tones is disclosed in K. J. Park, H. C. Ji, and Y. C. Chung, “Optical channel monitoring technique using phase-modulated pilot tones,” in Photonics Technology Letters, 2005, Vol. 17, No. 11. These techniques do not allow performance monitoring at real-time speeds.

### SUMMARY OF THE INVENTION

It is an object of the present invention to overcome or ameliorate at least one of the disadvantages of the prior art, or to provide a useful alternative.

It is an object of the invention, in its preferred form to provide an improved or alternative optical channel monitor.

In accordance with a first aspect of the present invention there is provided an optical channel monitor including:
one or more input optical ports for receiving an input optical signal including a plurality of optical channels;
a first monitoring module configured to selectively scan a predetermined spectral region of the optical signal including at least one optical channel; and
a second monitoring module configured to monitor a subregion within the predetermined spectral region.

In one embodiment, the second monitoring module is configured to slowly scan across the predetermined spectral region. In another embodiment, the second monitoring module is configured to statically monitor a fixed subregion. In one embodiment, the second monitoring module includes a coherent optical detector. In one embodiment, the first monitoring module includes a coherent optical detector.

The optical channels are preferably frequency modulated and the subregion preferably includes a band edge of an optical channel to thereby extract information about the frequency modulation of the channels contained therein.

The second monitoring module preferably includes a band-pass filter. The filter bandwidth of the band-pass filter is preferably a fraction of the bandwidth of an optical channel. The band-pass filter is preferably a scanning Fabry-Perot etalon configured to transmit a first optical signal including spectral components of the predetermined optical channels falling within the filter bandwidth and to reflect a second optical signal including spectral components of the predetermined optical channels falling outside the filter bandwidth. The Fabry-Perot etalon is preferably configured to slowly scan across the predetermined spectrum to obtain high resolution information about the optical channels contained therein.

In one embodiment, the free spectral range of the Fabry-Perot etalon is preferably greater than 50 GHz. In another embodiment, the free spectral range of the Fabry-Perot etalon is preferably equal to the channel spacing in the optical system.

The first optical signal preferably provides information indicative of the channel signal power absent noise, and the second optical signal preferably simultaneously provides information indicative of the channel total power, including noise, thereby allowing calculation of the optical signal-to-noise ratio for the channel.

The first optical signal preferably provides information indicative of the node origin of the optical channel in an optical system.

The frequency of modulation of the optical channels is preferably in the kHz frequency range. The frequency of modulation is preferably dependent on the particular node of origin in an optical system.

The first monitoring module preferably includes a diffraction grating to angularly separate wavelength channels from the input optical signal and at least one electronically controllable micro electro-mechanical mirror (MEMS) for selectively controlling the trajectory of the wavelength channels to select the predetermined spectral region. The input optical signal is preferably diffracted twice by the diffraction grating.

In accordance with a second aspect of the present invention, there is provided a method of monitoring optical channels within a wavelength division multiplexed (WDM) optical signal, the method including the steps of:
a) receiving the optical signal;
b) selectively scanning a predetermined spectral region of the optical signal including at least one optical channel; and
c) simultaneously with step b), monitoring a subregion within the predetermined spectral region.

In accordance with a third aspect of the present invention, there is provided an optical monitoring device for monitoring frequency modulated optical channels within an optical signal, the optical monitoring device including:
an input optical port for receiving the input optical signal;

a first monitoring module for selectively filtering a channel from the optical signal; and
a second monitoring module for monitoring a band edge of the filtered channel to thereby extract information about the frequency modulation of the channels.

In accordance with a fourth aspect of the present invention, there is provided an optical channel monitor for monitoring transmitted optical channels, the optical channel monitor including:
an input optical port for receiving the input optical channels;
a first monitoring module for scanning the optical channels at a high speed to obtain low resolution spectral information of each channel; and
a second monitoring module for scanning the optical channels at a slow speed to obtain high resolution spectral information of each channel simultaneously with the low resolution spectral data obtained by the first monitoring module.

In one embodiment, the scanning and monitoring is performed in a time division manner. In another embodiment, the scanning and monitoring is performed simultaneously in time. In one embodiment, the monitoring is performed statically on a fixed subregion.

### BRIEF DESCRIPTION OF THE DRAWINGS

Preferred embodiments of the invention will now be described, by way of example only, with reference to the accompanying drawings in which:

FIG. 1 is a schematic illustration of a first embodiment of an optical channel monitor showing spectral profiles at different points in the monitor;

FIG. 2 is a schematic illustration of a channel selecting module;

FIG. 3 is a schematic illustration of a second embodiment of a channel selecting module;

FIG. 4 is three graphs illustrating the position of the Fabry-Perot etalon passband relative to a channel bandwidth at different times during the modulation cycle of the frequency modulated channel;

FIG. 5 is an exemplary graph of an optical signal measured by the optical channel monitor;

FIG. 6 is a schematic illustration of a second embodiment of an optical channel monitor;

FIG. 7 is a schematic illustration of a third embodiment of an optical channel monitor; and

FIG. 8 is a schematic illustration of a fourth embodiment of an optical channel monitor.

### DETAILED DESCRIPTION

### Overview of the Optical Channel Monitor

Throughout the description of the various embodiments described herein, corresponding features have been given the same reference numerals.

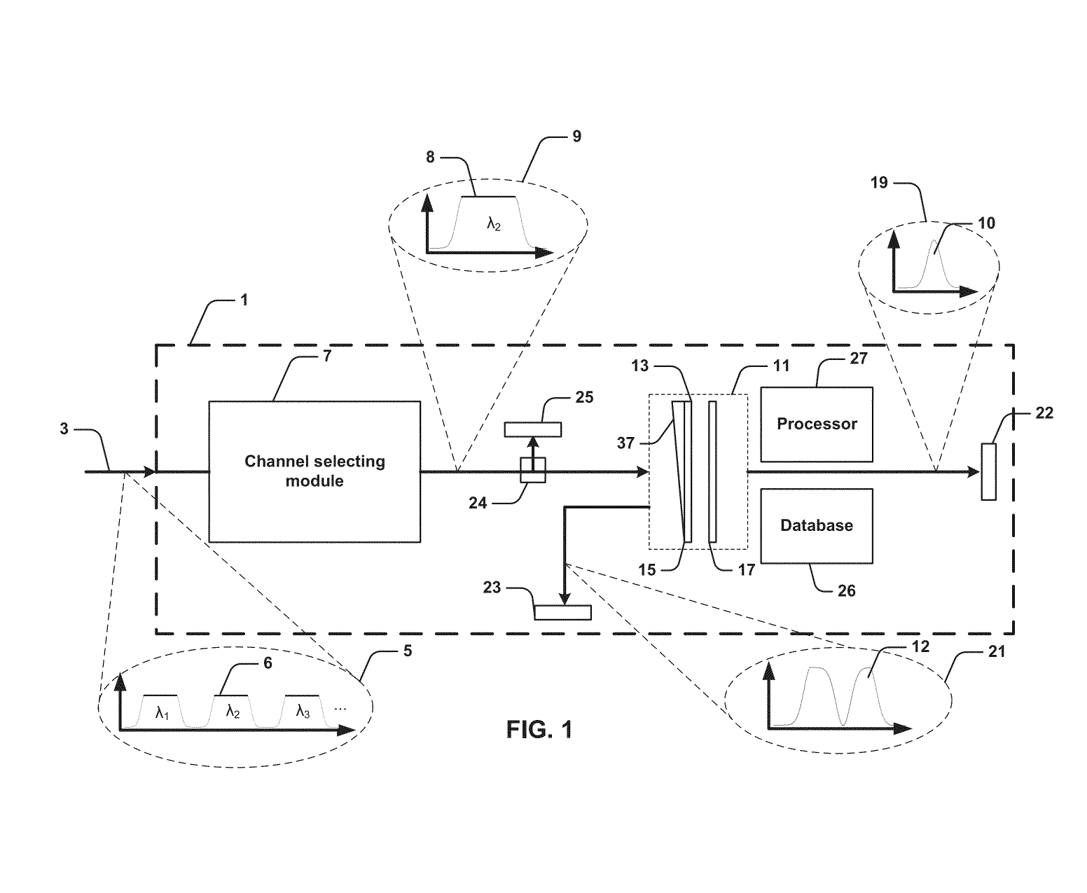

Referring to FIG. 1 there is illustrated schematically an optical channel monitor (OCM) 1 for monitoring frequency modulated optical channels transmitted through an optical transmission system. OCM 1 is configured to be coupled to an existing optical system by an optical coupler or optical tap at a desired point in the system.

OCM 1 is configured to receive wavelength division multiplexed (WDM) optical signals having optical channels spaced apart by a predetermined frequency. Examples of frequency separation of the optical channels are 12.5 GHz, 25 GHz, 50 GHz and 100 GHz. For the purpose of performance monitoring and channel tracking, the input laser signals which define the optical channels are frequency modulated by a sinusoidal signal, preferably in the KHz range. This frequency modulation will be described in more detail below. OCM 1 is able to monitor the performance of the optical system by tapping off a portion of the optical signal to OCM 1 at a desired point in the optical system.

OCM 1 includes input ports 3 (one shown) for receiving the tapped optical signal 5, which include the multiplexed and frequency modulated optical channels, as shown in spectrum 6. In the example case of FIG. 1, optical signal 5 includes only three optical channels (λ₁, λ₂ and λ₃). However, in practice, optical signals input to OCM 1 will often include tens or hundreds of optical channels multiplexed in a WDM manner. In the case where multiple optical signals are to be monitored, multiple input ports are provided and different channels from each optical signal are able to be monitored simultaneously.

Optical signal 5 is initially passed to a channel selecting module 7. Module 7 is configured to demultiplex the optical channels from optical signal 5 and to selectively filter predetermined optical channels for monitoring.

The demultiplexing and channel selection functions are performed simultaneously by a diffractive grism and a controllable microelectronic mirror (MEMs) similar to that described in US Patent Application Publication 2012/0281982 to Frisken and Abakoumov, entitled ‘Optical Channel Monitor’ (hereinafter Frisken and Abakoumov). The contents of this document are incorporated herein by way of cross-reference. One difference between embodiments described herein and that of Frisken and Abakoumov is the use of a single MEMs mirror rather than an array of independently controllable MEMs mirrors. However, in other embodiments of the present invention, an array of independently controllable MEMs mirrors is used in place of the single MEMs mirror. In further embodiments, different diffractive elements are implemented, such as diffraction gratings and fiber Bragg gratings. In various other embodiments, different switching elements are used together or separately, including lenses, mirrors, liquid crystal arrays and piezoelectric transducer arrays.

Module 7 quickly and periodically scans across the channels present in optical signal 5, outputting a filtered signal 9 having a spectrum including a single optical channel (λ₂ in the example case). In the case where a plurality of optical signals is input to OCM 1, module 7 is able to selectively filter different channels from each optical signal simultaneously.

The filtered signal 9, including the predetermined optical channel selected by module 7, is then passed to a spectral monitor module 11. Module 11 is configured to monitor a band edge of the predetermined optical channel for a predetermined period of time. Monitoring of the band edge allows extraction of information about the frequency modulation, which, in turn, allows determination of important channel characteristics, as will be described below.

Module 11 includes a scanning Fabry-Perot etalon 13, including a pair of opposing highly reflective but partially transparent optical plates 15 and 17. At least one of plates 15 or 17 is electronically movable along an optical axis to allow scanning of a transmission passband of the etalon over a predetermined frequency range. When the passband is centered over a band edge of a channel, the channel modulation is measurable. The free spectral range (FSR) of etalon 13 is equal to or greater than the spectral width of an optical channel so that module 11 only monitors one local spectral region of a channel at each instant of time. In a standard dense WDM optical transmission system, channels are spaced at 50 GHz intervals. In this system, it is preferable for the FSR of etalon 13 to be 50 GHz also so that module 11 monitors the same portion of each optical channel as the channels are scanned in time by module 7. In some embodiments, module 11 is not scanned but is maintained static and centered upon a particular spectral region.

Scanning of etalon 13 across a small spectral region or statically ‘staring’ at a particular spectral region allows high resolution information to be obtained on the channel shape. Scanning also allows flexibility in monitoring channels of different frequency or spectral width. In other embodiments, plates 15 and 17 of etalon 13 are fixed and the passband of etalon 13 is stationary at predetermined frequencies to only monitor channel band edges.

Etalon 13 defines a band-pass filter that is configured to transmit a band-pass filtered optical signal 19, including spectral components of the predetermined optical channels falling within the etalon passband (see example spectrum 18), and to reflect a band-stop optical signal 21, including spectral components of the predetermined optical channels falling outside the etalon passband (see example spectrum 20). Optical signals 19 and 21 are detected by respective optical detectors in the form of photodiodes 22 and 23. Similarly, signal 9 can be directly detected by tapping off a portion of the signal using an optical tap 24 prior to module 11 for detection by photodiode 25. Detectors 22, 23 and 25 convert optical signals 19 and 21 to electrical signals for analysis of the signal data. The data is able to be ported from OCM 1 to external processing devices such as personal computers.

The data received by photodiodes 22, 23 and 24 is optionally able to be stored in an internal database 26 and processed by processor 27. Database 26 is also configured for storing calibration data to be applied to the received signal data. Processor 27 may also be configured to apply a calibration to outgoing signal data being ported to an external device. In other embodiments, this storage and processing of data is performed externally to OCM 1. Database 26 and processor 27 are disposed on an integrated circuit (not shown) along with other electronic components such as control electronics for the MEMs mirror and components for powering OCM 1.

### Operation of the Optical Channel Monitor

The operation of OCM 1 will now be described with reference to FIGS. 1 to 5.

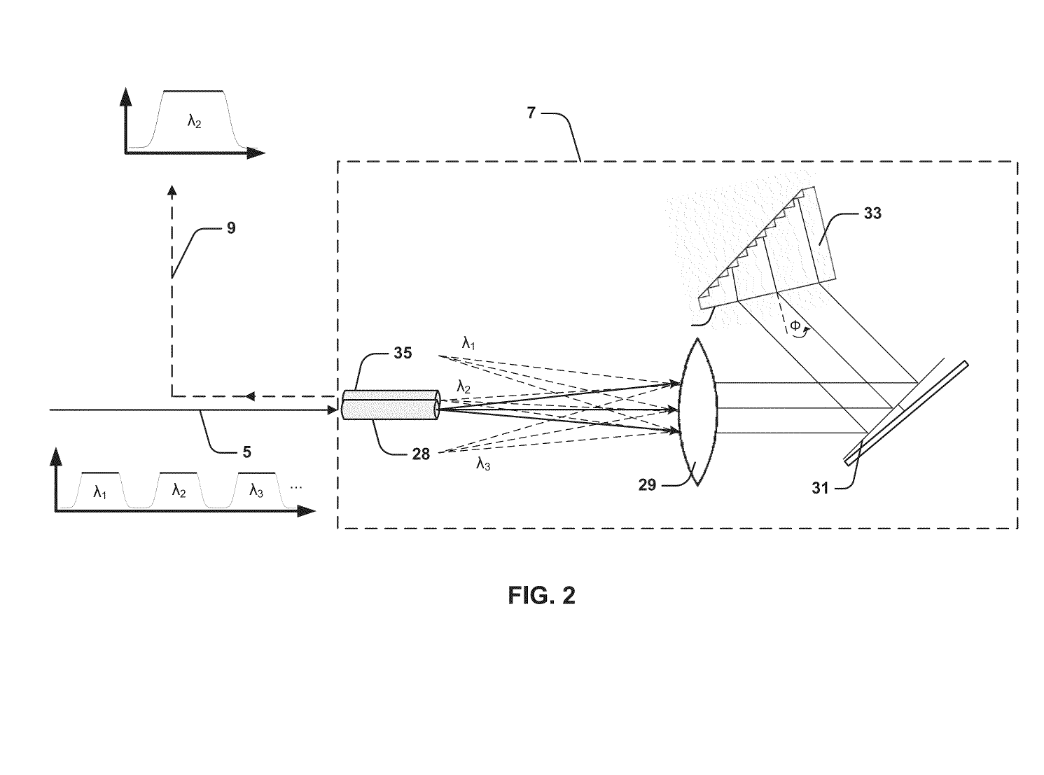

After input optical signal 5 (or a plurality of signals) is received at input ports 3, they are transmitted by optical fiber to module 7. A full description of module 7 is set out in Frisken and Abakoumov. However, the primary functions are summarized here with reference to FIG. 2, which illustrates schematically the primary elements of module 7.

An end of the optical fiber defines an input port 28 to module 7. Port 28 may also include coupling optics such as a micro-lens. Signal 5, in the form of an optical beam, projected from port 28 is incident onto a convex lens 29, which collimates the initially diverging optical beam. The collimated optical beam is directed onto MEMs mirror 31, which selectively directs the beam onto a diffractive grism 33 based on the particular mirror angles set. Grism 33 angularly separates the wavelength channels present in the optical signal by dispersion and reflects the channels back onto MEMs mirror 31. In another embodiment, grism 33 is replaced with a conventional reflective diffraction grating. The channels are directed by MEMs mirror 31 back through lens 29 at an angle such that one channel is focused into an output port 35 as filtered signal 9 and the remaining channels are coupled off-axis and attenuated. In the illustrated case, channel λ₂ is selected and channels λ₁ and λ₃ are filtered out.

MEMs mirror 31 periodically scans across a range of tilt angles about its tilt axis to sequentially couple predetermined optical channels to port 35 for monitoring. The scanning of optical channels by module 7 is performed sufficiently quickly to allow real or near real-time monitoring of each of the optical channels. The output signal 9 of module 7 includes substantially all of the spectral components of a predetermined channel at a predetermined time. Direct detection of signal 9 by an optical detector allows the total optical power in the channel and central wavelength to be estimated.

Module 7 is realized in a reflective configuration, having output port 35 adjacent to input port 28. It will be appreciated that module 7 is not limited to this design and, in other embodiments, module 7 outputs signal 9 at other orientations and positions relative to input signal 5. This may be achieved using a transmissive diffraction grating or additional beam direction elements to direct the beam in other directions and orientations.

Module 7 is able to perform the above described channel selection function simultaneously on a number of input optical signals. In another embodiment MEMs mirror 31 is replaced with an array of independently controlled MEMs mirrors (as in Frisken and Abakoumov) and a plurality of optical signals are input to OCM 1 simultaneously. In this embodiment, module 7 is able to simultaneously selectively filter different channels from each optical signal by projecting the different optical signals onto different spatial regions of the MEMs array and scanning the mirrors at different tilt angles. Accordingly, channels from multiple optical signals can be simultaneously monitored.

The filtered optical signal 9 output from module 7 is transmitted to module 11 by optical fiber. In another embodiment, optical signals propagate between modules 7 and 11 in free-space or through lens arrangements, rather than through optical fibers.

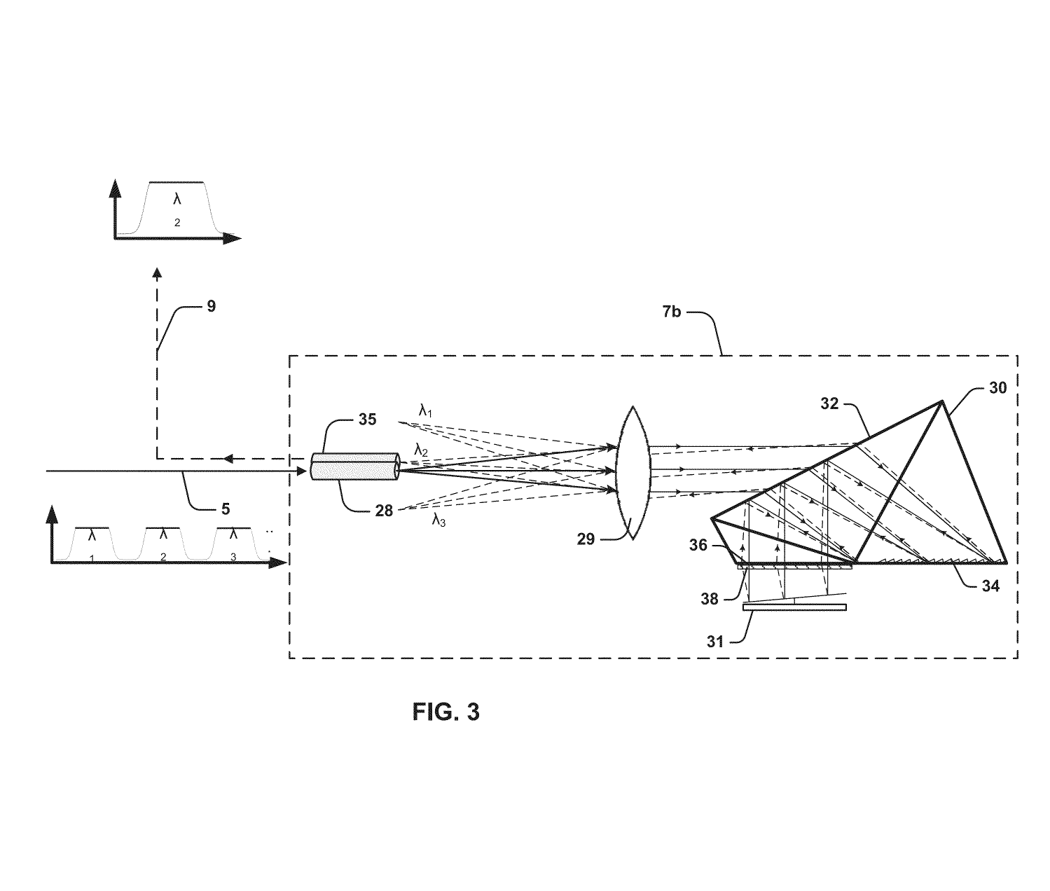

Referring now to FIG. 3, there is illustrated a further embodiment channel selecting module 7b. Module 7b includes an internal reflection prism 30 having an input/output surface 32, a diffraction grating 34 and a coupling surface 36 for coupling beams to MEMs steering mirror 31. A Faraday rotator 38 is situated adjacent to surface 36 to reduce any polarization dependence of the grating and surface coatings by rotating the polarization of the principal axis of the system on the return path. In some embodiments, Faraday rotator 38 is fixedly attached to prism 30. In other embodiments, Faraday rotator 38 is separate to prism 30. In another embodiment, appropriate waveplates are used in place of the Faraday Rotator. In a further embodiment, no polarization rotating element is included in module 7b.

In operation, beams passed through lens 29 are incident onto surface 32 of prism 30. The beams are passed into prism 30 and are refracted internally towards diffraction grating 34 which angularly disperses wavelength channels from the beams according to wavelength. The dispersed channels are reflected from grating 34 and propagate internally back towards surface 32 at slightly different angles. At surface 32, the channels are propagating at an angle such that they are reflected from surface 32 under total internal reflection. The reflected channels propagate through coupling surface 36 and are incident on MEMs steering mirror 31 which angularly steers the wavelength channels back through surface 36 into prism 30 along predetermined paths.

On the return trip from MEMs mirror 31, the wavelength channels are again internally reflected off surface 32 and diffracted a second time by diffraction grating 34 before exiting prism at surface 32. The channels propagate back through lens 29 at an angle such that only one of the channels is coupled back to output port 35. Selecting module 7b has advantages over module 7 of FIG. 2 in relation to size and better wavelength separation due to the double-pass of diffraction grating 34.

Returning to FIG. 1, at module 11, signal 9 is projected through etalon 13. Plates 15 and 17 of etalon 13 have inner surfaces that are planar, parallel and highly reflecting (greater than 90% reflecting). The outer surface of plate 15 includes an anti-reflective coating to substantially reduce the amount of signal 9 that is directly reflected from plate 15. The spacing between plates 15 and 17 defines a cavity that supports particular wavelengths falling within the etalon passband. The supported wavelengths are filtered out and projected through plate 17 as filtered signal 19. The passband of etalon 13 is a small fraction of the channel bandwidth, thereby allowing a thin ‘slice’ of the channel to be monitored. The remainder of signal 9 not falling within the etalon passband is reflected from etalon 13 and deflected by an outer angled surface 37 of plate 15 as signal 21. In other embodiments, reflected signal 21 is separated from signal 9 by other means including a directional optical isolator.

The spacing of plates 15 and 17 is electronically controllable to select the particular wavelengths within the etalon passband. By continuously changing the plate spacing, the passband frequency can be scanned across the channel spectrum, thereby allowing a high resolution picture of the optical channel to be obtained.

The rate of frequency scanning is much slower than the rate of switching of channels by module 7 so that module 11 effectively ‘stares’ at a region of a channel spectrum. If the free spectral range of etalon 13 matches the channel spacing, module 11 stares at the same region of consecutive channels that the predetermined channel selected by module 7 changes. As the plate spacing of etalon 13 is slowly adjusted, the particular channel region at which module 11 stares is shifted. By setting a plate spacing that supports wavelengths around the band edge of an optical channel, information about the modulation of that channel can be obtained.

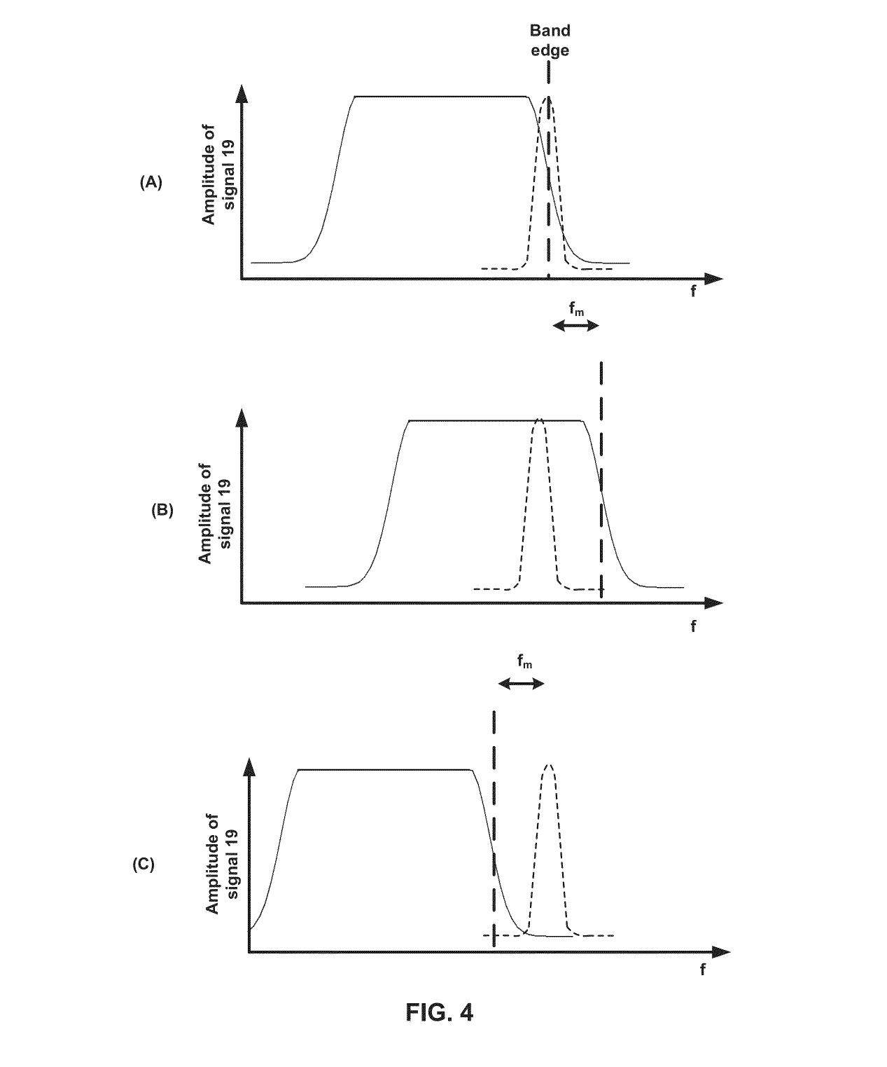

As the channel is frequency modulated upon input to the optical system, the channel spectrum shifts periodically over time, as does the channel band edge. Typical modulation frequencies are in the range of 10 to 50 kHz, but other frequency ranges are possible depending on the particular application. By situating the passband of etalon 13 over a channel band edge, the frequency modulation can be observed as a periodic fluctuation in amplitude of signal 19, as etalon 13 scans much slower than the modulation frequency. Referring to FIG. 4, there are illustrated three frames of a channel spectrum passed through module 11. The filter passband defined by etalon 13 is shown over-plotted as a dashed line. The different frames of FIG. 4 illustrate the spectral position of the optical channel at different periods in the modulation cycle. At frame (A), the pass-band of etalon 13 is centered on the band-edge of the channel. At frame (B), the band-edge has shifted to a higher frequency than the passband and at frame (C) the band-edge is positioned at a lower frequency than the passband.

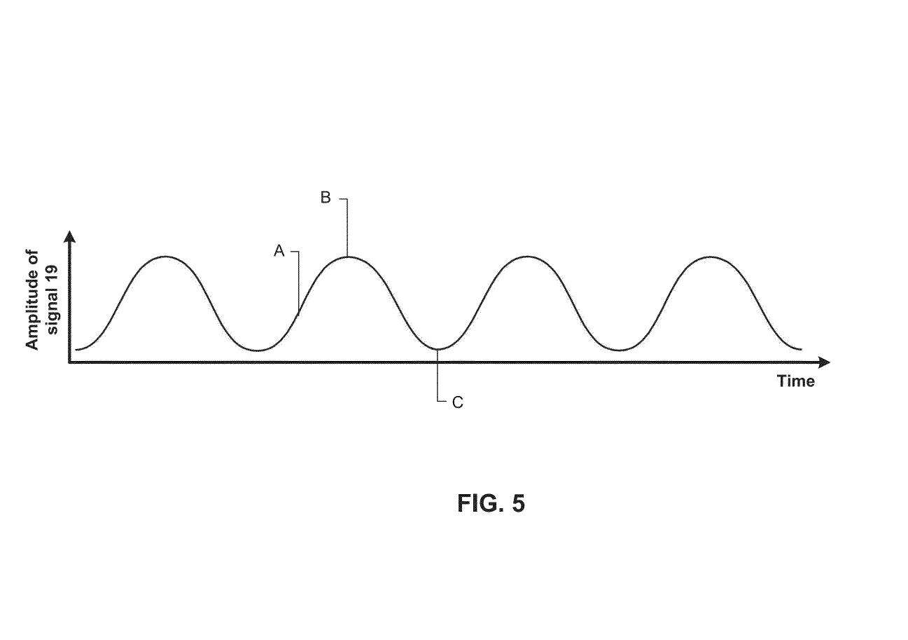

Referring to FIG. 5, there is shown a graph of amplitude modulation of signal 19 measured as a function of time. Points A, B and C correspond to measurements taken at filter positions shown in frames (A), (B) and (C) of FIG. 4 respectively. Reviewing FIG. 5 in conjunction with FIG. 4, it is observed that when the passband of etalon 13 is centered on the channel band-edge it will output moderate amplitude, as shown in A of FIG. 5. A quarter of a modulation cycle later, the passband of etalon 13 is located within the channel bandwidth and signal 19 is a maximum. A half-cycle later again the passband of etalon 13 is located outside the channel bandwidth and signal 19 measures a minimum. The resulting shape of signal 19 is sinusoidal, as shown in FIG. 5.

Measurements taken at points B are indicative of the peak optical power of the channel. Measurements taken at points C are indicative of the noise floor only, with very little channel power present. Therefore, the OSNR of the optical channel can be calculated as follows:

$$OSNR ( {λ}_{n} ) = \frac{B - C}{B}$$

In other embodiments, more advanced calculations of OSNR can be made by taking multiple amplitude measurements across the channel and factoring in the spectral shape of the channel.

The frequency of the modulation of signal 19 can be easily measured after several cycles of the modulation are observed. The measured frequency can be compared to the known modulation frequencies applied to the channels at an input node of the optical system, thereby allowing identification of the node of origin of each optical channel.

The manner in which the frequency modulation is applied to the optical channels is flexible and should not affect the ability of OCM 1 to detect the modulation. It is known that many standard laser sources used in optical transmission systems include a pre-coded triangular frequency modulation to reduce Bruillion backscattering in the laser. This pre-coded frequency modulation is able to be detected by OCM 1 for determining OSNR of channels and also the node origin of channels, provided the modulation has a frequency unique to that laser source. This detection removes the need to externally modulate the laser sources in the optical system by frequency modulators, thereby reducing overall system cost.

Signals 9 and 19 of FIG. 1 are able to be detected simultaneously on separate photodiodes, enabling a fast, low resolution scan, together with a slow, higher resolution (˜1 GHz) scan of each optical channel.

High resolution measurements of the channel spectra can allow estimation of the channel slope. Knowing this information can be helpful if knowledge of the initial channel band edge slope is available. In particular, at each node in an optical system, often a reconfigurable optical add/drop multiplexer (ROADM), generally broadens the channel spectrum and flattens the band edge. Monitoring of the slope evolution can allow more accurate measurements of OSNR. The initial slope can be used as a calibration function and be applied to the broadened slope to more accurately detect the correct frequency modulation. This leads to more accurate OSNR measurements.

Furthermore, a comparison of the detected channel band edge slope with the initial slope at transmission allows an estimation of the number of nodes through which a channel has passed in an optical system.

### Additional Embodiments

While illustrated as a unitary device, in an alternative embodiment, module 11 is able to be constructed separately and retrofitted to existing OCMs such as that disclosed in Frisken and Abakoumov. In further embodiments, module 11 is configured to be fitted to a wavelength selective switch device to monitor specific optical channels being switched or routed through the switch.

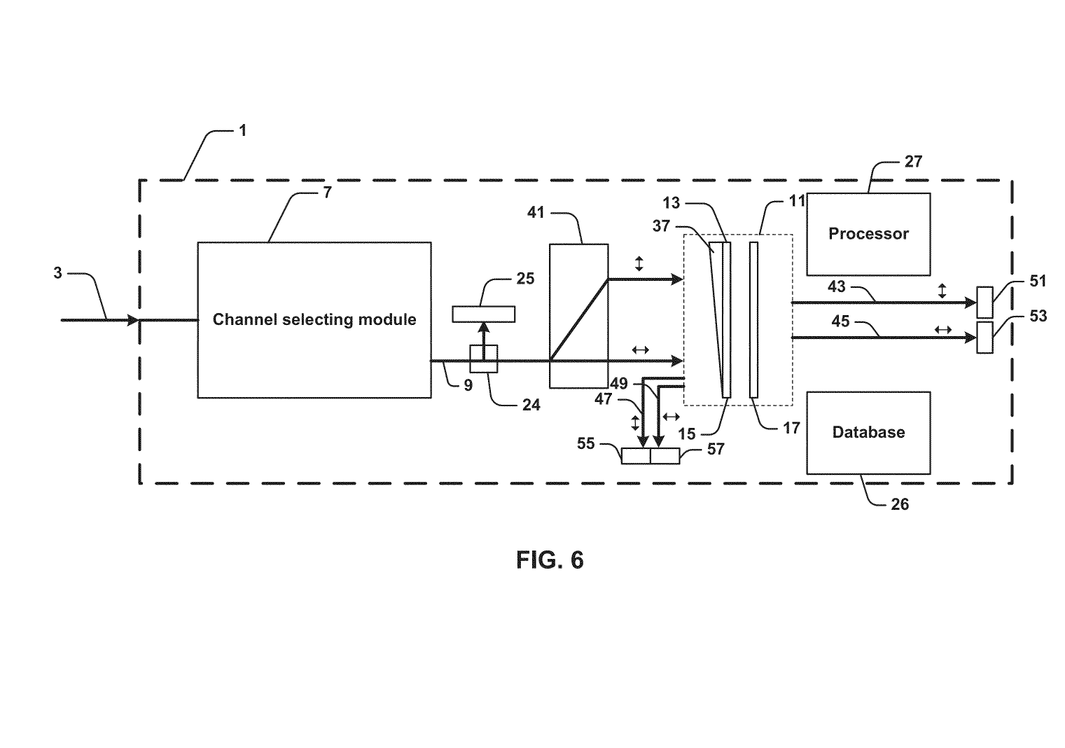

Referring to FIG. 6, there is illustrated schematically an OCM 39 according to a second embodiment of the invention. Corresponding features of OCM 1 are designated with the same reference numerals. OCM 39 operates in a similar fashion to OCM 1 described above, but is also capable of calculating the polarization properties of the detected signals. OCM 39 includes a polarization beam splitter in the form of a birefringent crystal 41 disposed between modules 7 and 11 for splitting signal 9 into two spatially separated orthogonal polarization components. In FIG. 6, vertical and horizontal polarization components are chosen for clarity. However, it will be appreciated that crystal 41 can be configured to produce any two arbitrary orthogonal polarization components. In other embodiments, other polarization splitting elements are used such as birefringent wedges.

The two orthogonal polarization components are passed through module 11 separately to produce two filtered polarized signals 43 and 45, and two reflected polarization signals 47 and 49. Each signal 43, 45, 47 and 49 is detected by a respective photodiode 51, 53, 55 and 57. Comparison of transmitted signals 43 and 45 and reflected signals 47 and 49 yields information on each polarization state, such as polarization mode dispersion present in the optical system.

Although illustrated as separate elements, in some embodiments the channel selecting module 7 and spectral monitor module 11 are performed by the same optical elements or share one or more optical elements. In these and other embodiments, the scanning function performed by the channel selecting module 7 and the staring function performed by the spectral monitor module 11 may be performed in a time division or time multiplexed manner.

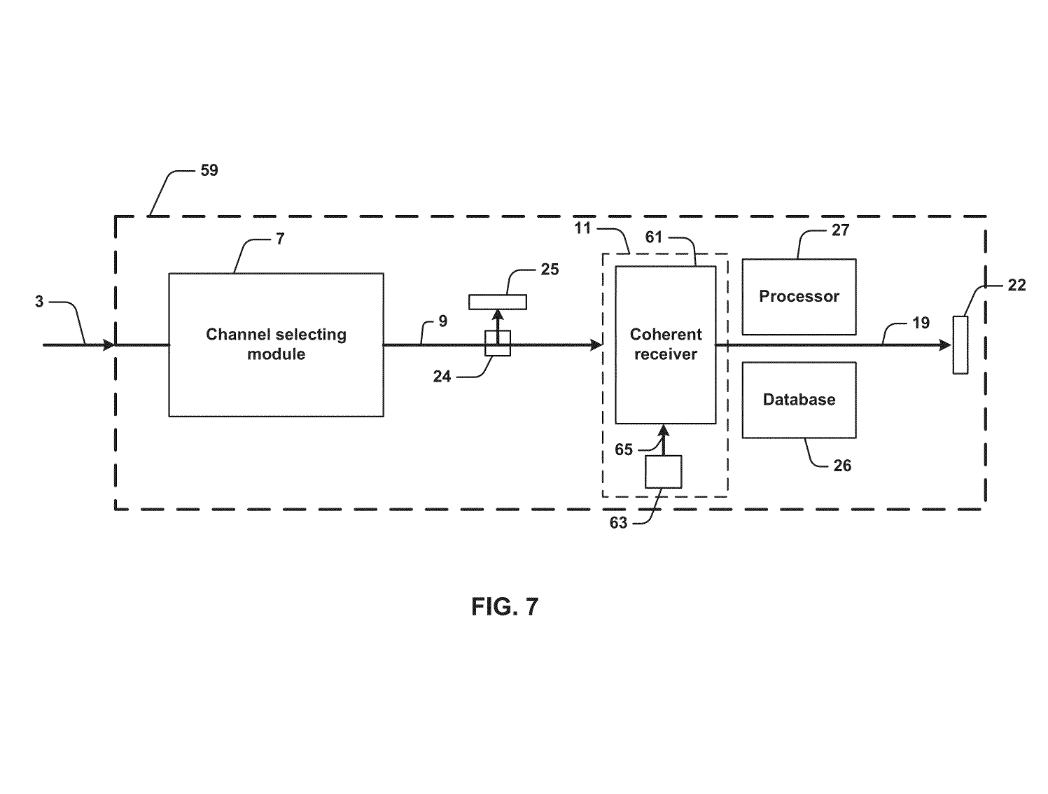

In other embodiments, one or both of the channel selecting module 7 or spectral monitor module 11 include a coherent receiver. Referring to FIG. 7, there is illustrated schematically an OCM 59 according to a third embodiment of the invention. Corresponding features of OCM 1 are designated with the same reference numerals. In OCM 59, module 11 includes a coherent receiver 61 for monitoring a band edge of the predetermined optical channels. Module 11 also includes a local oscillator in the form of a laser 63, which provides a controllable local oscillator signal 65 to coherent receiver 61. Signals 9 and 65 are input to coherent receiver 61, which mixes the signals to produce output signal 19. Signal 19 includes only the spectral components of signal 9 that mix coherently with signal 65. Therefore, coherent receiver 61 is used as a controllable band-pass filter with passband wavelengths set by the wavelength of oscillator signal 65. Laser 63 is controlled to output signal 65 at a fixed wavelength (or slowly scanning across a small range of wavelengths) for a predetermined time so as to ‘stare’ at a desired spectral region of an optical channel.

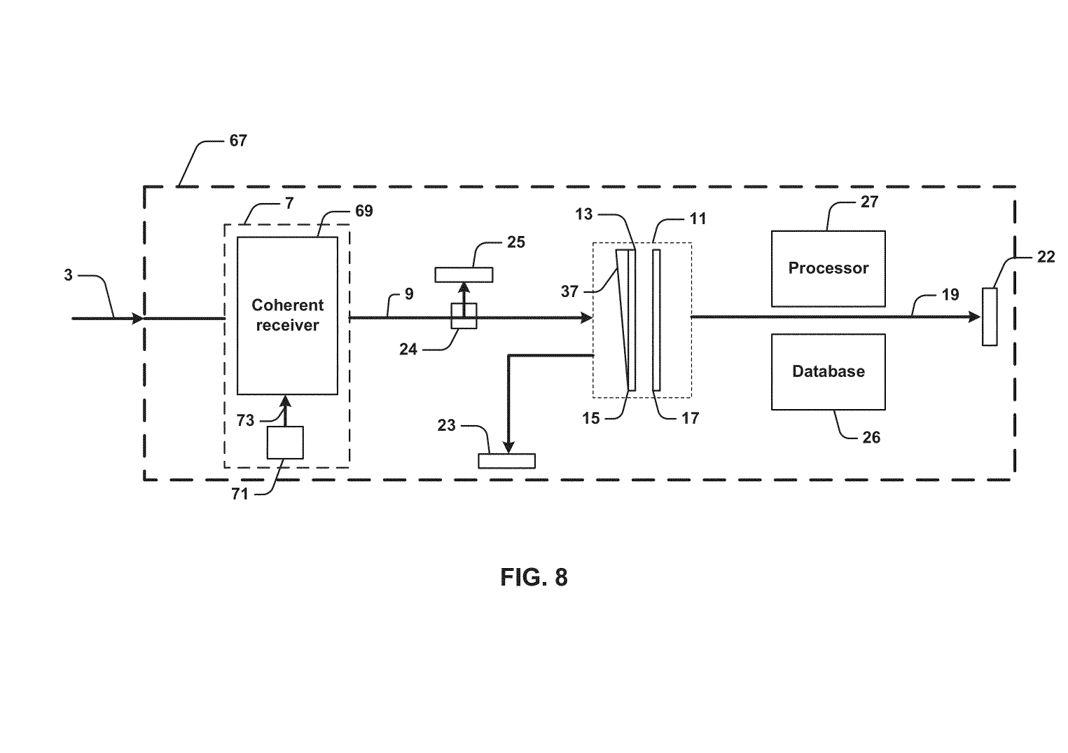

Referring to FIG. 8, there is illustrated schematically an OCM 67 according to a fourth embodiment wherein the channel selecting module 7 includes a coherent receiver 69 and a tunable laser 71. Corresponding features of OCM 1 are designated with the same reference numerals. In OCM 67, tunable laser 71 is configured to scan across a range of wavelengths covering the wavelength channels and input a tunable local oscillator signal 73 to receiver 69. Signal 73 is mixed with input signal 3 and only wavelengths of signal 3 that are coherent with signal 73 are output as signal 9. The remaining incoherent signals are attenuated. By scanning laser 71, the receiver/laser combination act as a scanning band pass filter and perform a similar operation to the MEMS/grism combination of OCM 1. In OCM 67, spectral monitor module 11 operates in the same manner as in OCM 1.

### CONCLUSIONS

It will be appreciated that the disclosure above provides an improved or alternative optical channel monitor.

The described optical channel monitor is capable of measuring the OSNR and node origin of a wavelength channel simultaneously with the more conventional channel measurements of optical power and central wavelength. Direct detection of signal 9 provides a fast measurement of the power of an optical channel. Detection of signal 19 provides relatively higher resolution (˜1 GHz) information on each optical channel at a slower scan rate or in a stationary state. Such higher resolution information includes the channel spectrum shape, modulation frequency, OSNR and node origin.

The optical channel monitor of the present invention allows real-time monitoring of an optical channel simultaneously or time multiplexed with high resolution monitoring to measure characteristics such as OSNR and node origin.

### Interpretation

Throughout this specification, use of the term “element” is intended to mean either a single unitary component or a collection of components that combine to perform a specific function or purpose.

Reference throughout this specification to the terms “optical beam” are intended to mean, and be used synonymously with, the terms “optical signal” to describe the WDM signal to be monitored by the optical channel monitor. Reference is particularly made to “optical beam” as the WDM signal is often described in terms of spatial characteristics and propagation, which, for ease of understanding, is more clearly described by the term “beam” rather than “signal”. However, it will be appreciated that such “optical beams” include the wavelength information and propagation characteristics indicative of a transmitted optical signal.

It will also be appreciated that the term “optical” used in this specification is not intended to restrict the notion of optical beams and beams being in the visual range of electromagnetic waves. Rather, the term “optical” is used to refer to any range of electromagnetic waves that can be controlled and manipulated in the appropriate manner by the described optical channel monitor. Such electromagnetic waves generally include, but are not limited to infrared, visual, and ultra-violet wavelengths.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily, but may all be referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising,” “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms “including,” or “which includes” or “that includes” as used herein is also an open term that also means including at least the elements/features that follow the term, but not excluding others. Thus, including is synonymous with and means comprising.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some, but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

It is to be observed that the term “coupled,” when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B, which may be a path including other devices or means. “Coupled” may mean that two or more elements are either in direct physical, electrical or optical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. An optical channel monitor including:
one or more input optical ports for receiving an input optical signal including a plurality of optical channels;
a first monitoring module configured to selectively scan a predetermined spectral region of the optical signal including at least one optical channel; and
a second monitoring module configured to monitor a subregion within the predetermined spectral region.

2. An optical channel monitor according to claim 1 wherein the optical channels are frequency modulated and the subregion includes a band edge of an optical channel to thereby extract information about the frequency modulation of the channels contained therein.

3. An optical channel monitor according to claim 1 wherein the second monitoring module is configured to slowly scan across the predetermined spectral region.

4. An optical channel monitor according to claim 1 wherein the second monitoring module is configured to statically monitor a fixed subregion.

5. An optical channel monitor according to claim 1 wherein the second monitoring module includes a coherent optical detector.

6. An optical channel monitor according to claim 1 wherein the first monitoring module includes a coherent optical detector.

7. An optical channel monitor according to claim 1 wherein the second monitoring module includes a band-pass filter.

8. An optical channel monitor according to claim 7 wherein the filter bandwidth of the band-pass filter is a fraction of the bandwidth of an optical channel.

9. An optical channel monitor according to claim 7 wherein the band-pass filter is a scanning Fabry-Perot etalon configured to transmit a first optical signal including spectral components of the predetermined optical channels falling within the filter bandwidth and to reflect a second optical signal including spectral components of the predetermined optical channels falling outside the filter bandwidth.

10. An optical channel monitor according to claim 9 wherein the Fabry-Perot etalon is configured to slowly scan across the predetermined spectrum to obtain high resolution information about the optical channels contained therein.

11. An optical channel monitor according to claim 5 wherein the free spectral range of the Fabry-Perot etalon is greater than 50 GHz.

12. An optical channel monitor according to claim 9 wherein the free spectral range of the Fabry-Perot etalon is equal to the channel spacing in the optical system.

13. An optical channel monitor according to claim 9 wherein the first optical signal provides information indicative of the channel signal power absent noise, and the second optical signal simultaneously provides information indicative of the channel total power including noise, thereby allowing calculation of the optical signal-to-noise ratio for the channel.

14. An optical channel monitor according to claim 9 wherein the first optical signal provides information indicative of the node origin of the optical channel in an optical system.

15. An optical channel monitor according to claim 2 wherein the frequency of modulation of the optical channels is in the kHz frequency range.

16. An optical channel monitor according to claim 2 wherein the frequency of modulation is dependent on the particular node of origin in an optical system.

17. An optical channel monitor according to claim 1 wherein the first monitoring module includes a diffraction grating to angularly separate wavelength channels from the input optical signal and an electronically controllable micro electro-mechanical mirror (MEMS) for selectively controlling the trajectory of the wavelength channels to select the predetermined spectral region.

18. A method of monitoring optical channels within a wavelength division multiplexed (WDM) optical signal, the method including the steps of:
d) receiving the optical signal;
e) selectively scanning a predetermined spectral region of the optical signal including at least one optical channel; and
f) monitoring a subregion within the predetermined spectral region.

19. A method according to claim 18 wherein the scanning and monitoring is performed in a time division manner.

20. A method according to claim 18 wherein the monitoring is performed statically on a fixed subregion.
